(19) United States
(12) Patent Application Publication
(10) Pub. No.: US 2014/0316840 A1
(43) Pub. Date: Oct. 23, 2014

(54) APPARATUS AND METHOD FOR EVALUATION OF ENGINEERING LEVEL

(71) Applicant: Hitachi, Ltd., Tokyo (JP)

(72) Inventors: Hiroko NISHIKAWA, Tokyo (JP); Hidenori KIUCHI, Tokyo (JP); Tetsuro ADACHI, Tokyo (JP); Kentaro TAGUCHI, Tokyo (JP); Xue ZHANG, Shanghai (CN)

(73) Assignee: Hitachi, Ltd., Tokyo (JP)

(21) Appl. No.: 14/253,378

(22) Filed: Apr. 15, 2014

(30) Foreign Application Priority Data
Apr. 17, 2013 (JP) 2013-086760

(51) Int. Cl. G06Q 10/06

(52) U.S. Cl. CPC G06Q 10/06315
USPC 705/7.25

(57) ABSTRACT

To provide a technology for assisting selection of a supplier that can guarantee appropriate quality with ease, provided is an engineering level evaluation apparatus, including: a storage unit which stores: device information in which information on a part and an apparatus relating to manufacturing of the part are associated with each other; and apparatus owning information in which information identifying a supply entity of the part and the apparatus used by the supply entity are associated with each other; a part information reception section which receives an input of the information on the part; an engineering level calculation section which identifies a degree to which the apparatus relating to the manufacturing of the part received by the part information reception section is usable, and uses the degree to calculate an engineering level of each supply entity; and an output unit which outputs the supply entities in order of the engineering level.

### BACKGROUND OF THE INVENTION

The present invention relates to an apparatus for evaluating an engineering level. The present invention claims priority to Japanese Patent Application No. 2013-86760 filed on Apr. 17, 2013, the contents of which are incorporated herein by reference in its entirety.

One example of the background art in this technical field is disclosed in Japanese Patent Laid-open Publication No. 2002-342626 as “This vender information management system is provided with a vender terminal for transmitting vender information through a communication network, a plurality of department terminals for transmitting vender nonconformity information, order results information and evaluation information, a vender information receiving means for receiving the vender information transmitted from each vender terminal and the order results information and the evaluation information transmitted from each of the department terminals, a nonconformity information receiving means for receiving nonconformity information about each vender transmitted from the respective department terminals, a vender information storing means for storing the vender information, the order results information and the evaluation information received by the vender information receiving means while associating with corresponding venders, and a nonconformity information storing means for storing the nonconformity information received by the nonconformity information receiving means.”

When a supplier is selected by using the above-mentioned technology, it is possible to refer to information such as order placement results, but it may be difficult for a person other than a richly-experienced buyer to select the supplier that guarantees appropriate quality.

### SUMMARY OF THE INVENTION

An object of the present invention is to provide a technology for assisting selection of a supplier that can guarantee appropriate quality with ease.

One embodiment of the present invention includes a plurality of means for solving at least a part of the above-mentioned problem, an example of which is as follows. In order to solve the above-mentioned problem, according to one embodiment of the present invention, there is provided an engineering level evaluation apparatus, including: a storage unit which stores: device information in which information on a part and an apparatus relating to manufacturing of the part are associated with each other; and apparatus owning information in which information identifying a supply entity of the part and the apparatus used by the supply entity are associated with each other; a part information reception section which receives an input of the information on the part; an engineering level calculation section which identifies a degree to which the apparatus relating to the manufacturing of the part received by the part information reception section is usable, and uses the degree to calculate an engineering level of each supply entity; and an output unit which outputs the supply entities in order of the engineering level.

According to one embodiment of the present invention, it is possible to assist the selection of the supplier that can guarantee the appropriate quality with ease. Objects, configurations, and effects other than those described above become more apparent from the following description of embodiments of the present invention.

### BRIEF DESCRIPTION OF THE DRAWINGS

FIG. 1 is a diagram illustrating a configuration example of an engineering level evaluation system according to a first embodiment of the present invention.

FIG. 2 shows a data structure stored in a manufacturing apparatus defect information storing section.

FIG. 3 shows a data structure stored in an inspection apparatus information storing section.

FIG. 4 shows a data structure stored in an owned manufacturing apparatus storing section.

FIG. 5 shows a data structure stored in an owned inspection apparatus storing section.

FIG. 6 is a diagram illustrating a hardware configuration of a supplier engineering level evaluation apparatus.

FIG. 7 is a diagram illustrating a processing flow of engineering level evaluation processing according to the first embodiment.

FIG. 8 is a diagram illustrating a processing example of the engineering level evaluation processing according to the first embodiment.

FIG. 9 is a diagram illustrating an output example of the engineering level evaluation processing according to the first embodiment.

FIG. 10 is a diagram illustrating a processing flow of engineering level evaluation processing according to a second embodiment of the present invention.

FIG. 11 is a diagram illustrating a processing example of the engineering level evaluation processing according to the second embodiment.

FIG. 12 is a diagram illustrating an output example of the engineering level evaluation processing according to the second embodiment.

FIG. 13 shows a data structure stored in a manufacturing apparatus coefficient storing section.

FIG. 14 shows a data structure stored in an inspection apparatus coefficient storing section.

FIG. 15 shows a data structure stored in an owned manufacturing apparatus storing section.

FIG. 16 shows a data structure stored in an owned inspection apparatus storing section.

FIG. 17 is a diagram illustrating a processing flow of engineering level evaluation processing according to a third embodiment of the present invention.

FIG. 18 is a diagram illustrating a processing example of the engineering level evaluation processing according to the third embodiment.

### DESCRIPTION OF THE PREFERRED EMBODIMENTS

Now, a description is made of an engineering level evaluation system 1 serving as an example of a system functioning as a system which evaluates an engineering level according to a first embodiment of the present invention with reference to the accompanying drawings.

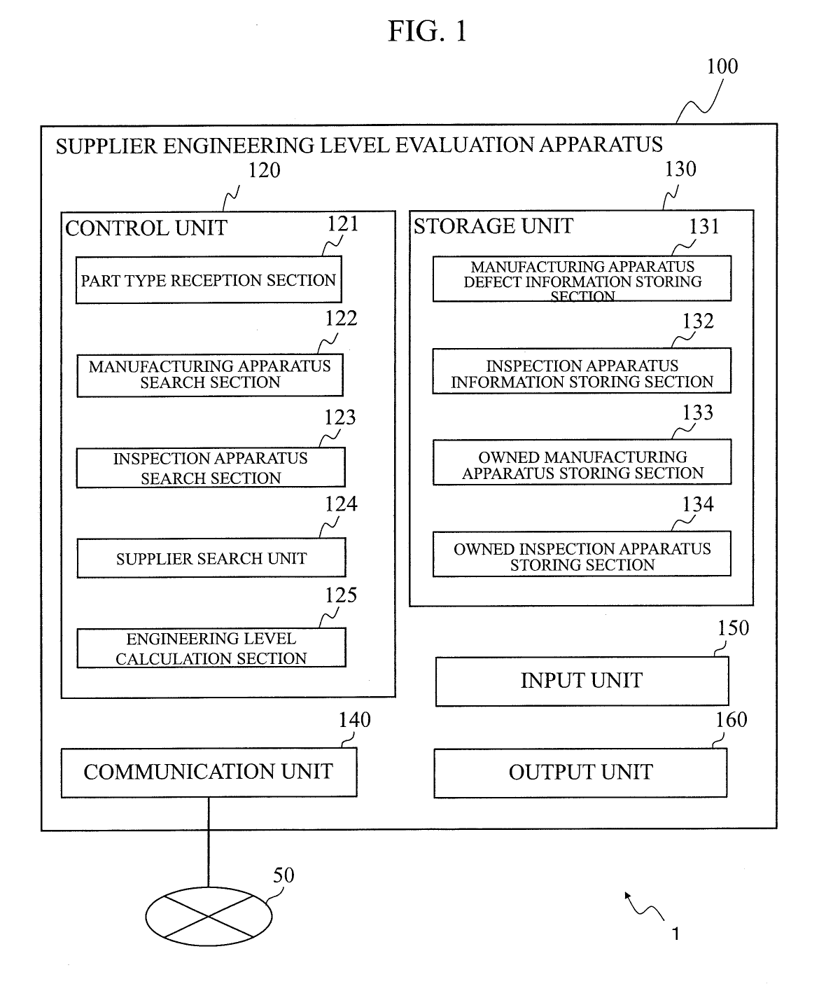

FIG. 1 is a diagram illustrating a configuration example of the entire engineering level evaluation system 1 according to the first embodiment of the present invention. The engineering level evaluation system 1 includes a supplier engineering level evaluation apparatus 100, and the supplier engineering level evaluation apparatus 100 is connected to a network 50 such as the Internet to be able to communicate to/from another apparatus. The supplier engineering level evaluation apparatus 100 includes a control unit 120, a storage unit 130, a communication unit 140, an input unit 150, and an output unit 160.

The storage unit 130 includes a manufacturing apparatus defect information storing section 131, an inspection apparatus information storing section 132, an owned manufacturing apparatus storing section 133, and an owned inspection apparatus storing section 134.

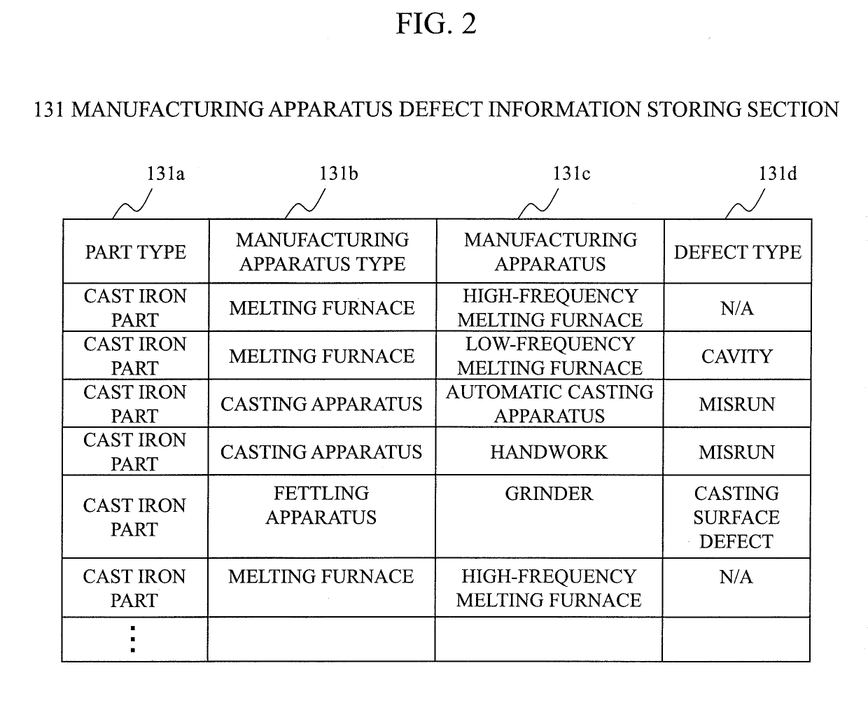

FIG. 2 shows a data structure stored in the manufacturing apparatus defect information storing section 131. The manufacturing apparatus defect information storing section 131 stores a plurality of pieces of information in each of which a part type 131a, a manufacturing apparatus type 131b, a manufacturing apparatus 131c, and a defect type 131d are associated with one another. The part type 131a is information identifying a type of a part to be manufactured, and examples thereof include “cast iron part”. The manufacturing apparatus type 131b is information identifying a type of an apparatus which can manufacture the part of the type identified by the part type 131a, and examples thereof include “melting furnace”. The manufacturing apparatus 131c is information identifying the apparatus which can manufacture the part of the type identified by the part type 131a, and examples thereof include “high-frequency melting furnace”. The defect type 131d is information identifying a type of a defect that is liable to occur when the part of the type identified by the part type 131a is manufactured by the manufacturing apparatus 131c, and examples thereof include “cavity”.

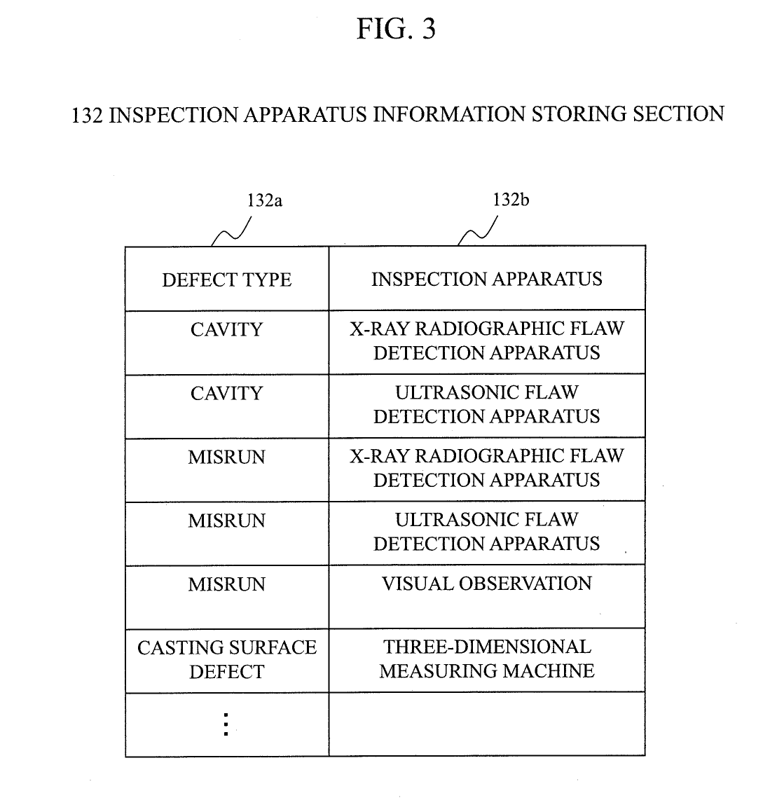

FIG. 3 shows a data structure stored in the inspection apparatus information storing section 132. The inspection apparatus information storing section 132 stores a plurality of pieces of information in each of which a defect type 132a and an inspection apparatus 132b are associated with each other. The defect type 132a is information identifying a kind of the defect to be detected by inspection, and examples thereof include “cavity”. The inspection apparatus 132b is information identifying an apparatus that can perform inspection to detect the defect of the type identified by the defect type 132a, and examples thereof include “X-ray radiographic flaw detection apparatus”.

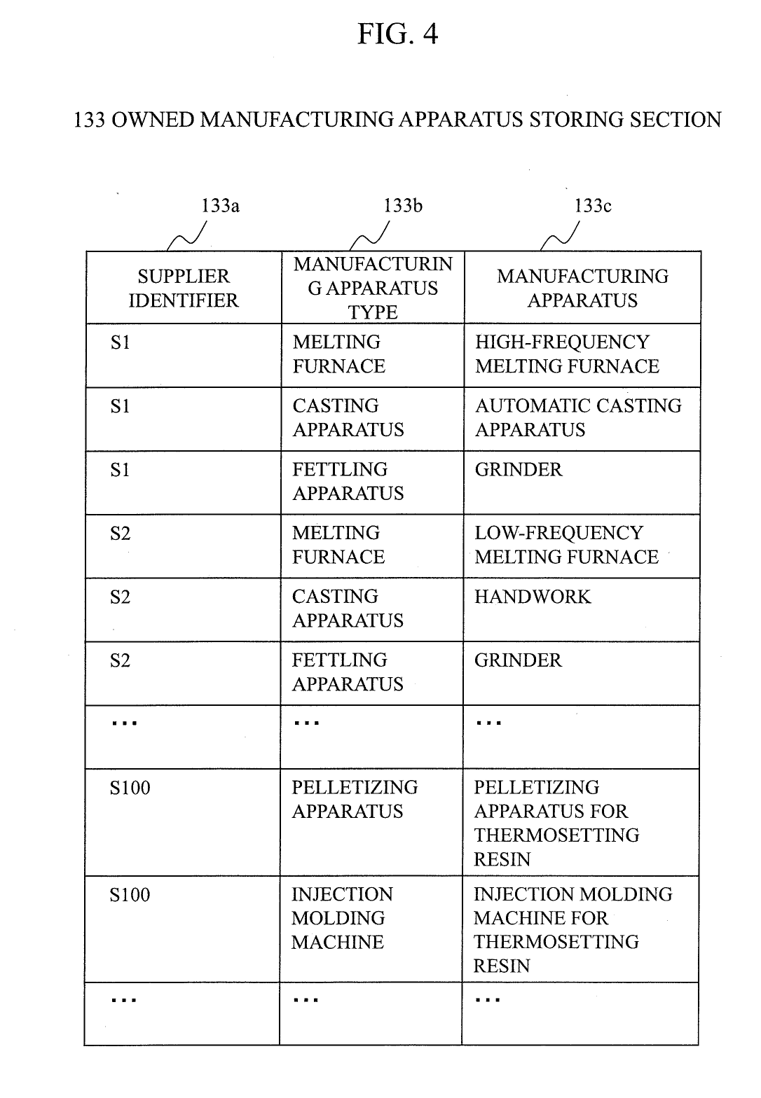

FIG. 4 shows a data structure stored in the owned manufacturing apparatus storing section 133. The owned manufacturing apparatus storing section 133 stores a plurality of pieces of information in each of which a supplier identifier 133a, a manufacturing apparatus type 133b, and a manufacturing apparatus 133c are associated with one another. The supplier identifier 133a is information identifying a supplier which owns a manufacturing apparatus. The manufacturing apparatus type 133b is information identifying a type of the manufacturing apparatus 133c owned by the supplier identified by the supplier identifier 133a, and examples thereof include “melting furnace”. The manufacturing apparatus 133c is information identifying the manufacturing apparatus owned by the supplier identified by the supplier identifier 133a, and examples thereof include “high-frequency melting furnace”.

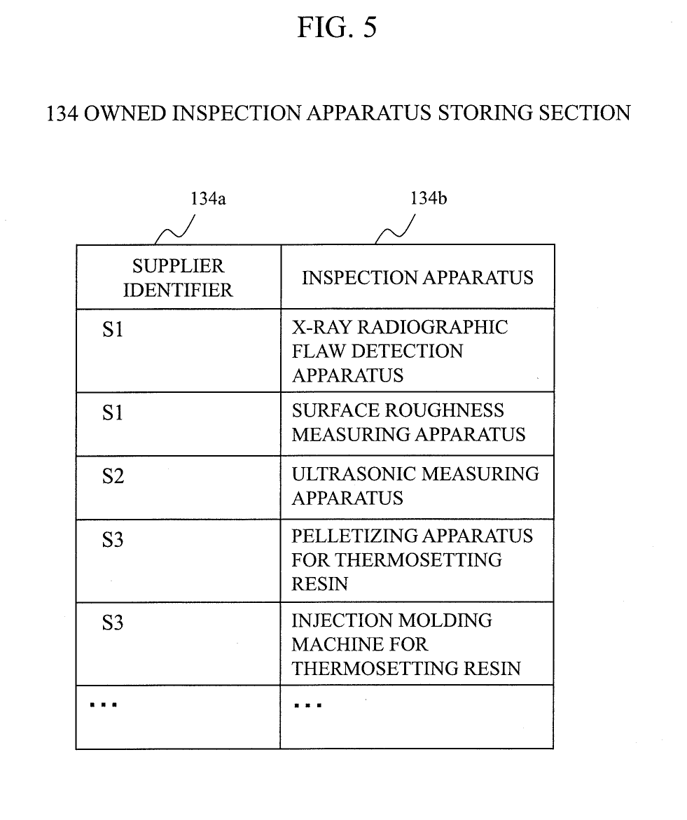

FIG. 5 shows a data structure stored in the owned inspection apparatus storing section 134. The owned inspection apparatus storing section 134 stores a plurality of pieces of information in each of which a supplier identifier 134a and an inspection apparatus 134b are associated with one another. The supplier identifier 134a is information identifying a supplier which owns an inspection apparatus. The inspection apparatus 134b is information identifying an inspection apparatus owned by the supplier identified by the supplier identifier 134a, and examples thereof include “X-ray radiographic flaw detection apparatus”. Note that, an apparatus which later inspects what has been manufactured in actuality is assumed as the inspection apparatus, but the present invention is not limited thereto, and the inspection apparatus may include a simulator such as a fluid simulator and a stress simulator in a sense that a defect is prevented in a design stage from occurring in a manufacturing stage.

The description returns to FIG. 1. The control unit 120 includes apart type reception section 121, a manufacturing apparatus search section 122, an inspection apparatus search section 123, a supplier search unit 124, and an engineering level calculation section 125. The part type reception section 121 receives an input of the type of the part based on which to evaluate the supplier. The manufacturing apparatus search section 122 searches for the manufacturing apparatus that can manufacture the part of the type received by the part type reception section 121. The inspection apparatus search section 123 searches for an apparatus which can perform inspection as to whether or not there is a defect that may be contained, in other words, which can detect the defect, in units of the manufacturing apparatus retrieved by the manufacturing apparatus search section 122. The supplier search unit 124 performs processing for searching for the manufacturing apparatus owned by the supplier based on the part type and processing for searching for the inspection apparatus owned by the supplier based on the defect type. The engineering level calculation section 125 calculates an engineering level of each supplier mainly based on an extent to which the manufacturing apparatus and the inspection apparatus are owned.

The communication unit 140 performs communications to/from another apparatus through the network 50 such as the Internet.

The input unit 150 receives input information from a user.

The output unit 160 generates output information such as screen information to be output to the user.

Note that, the storage unit 130 may be provided to another apparatus connected through the network 50 to allow the control unit 120 to access the information stored in the storage unit 130 via the communication unit 140.

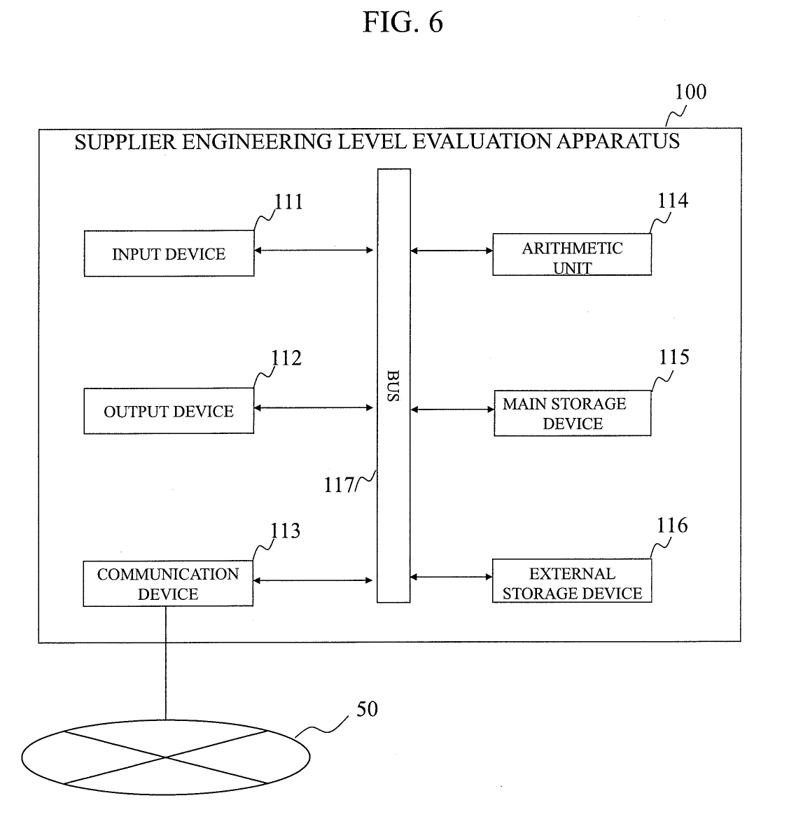

FIG. 6 is a diagram illustrating a hardware configuration of the supplier engineering level evaluation apparatus 100. The supplier engineering level evaluation apparatus 100 is typically a personal computer apparatus, but the present invention is not limited thereto, and the supplier engineering level evaluation apparatus 100 may be an electronic information terminal such as a mobile phone terminal and a personal digital assistant (PDA). Further, instead of directly accessing the network 50, the supplier engineering level evaluation apparatus 100 may access the network 50 through a communication network using circuit switching provided by a cellular phone carrier or the like, a wireless communication network for data transmission, or the like.

The supplier engineering level evaluation apparatus 100 includes an input device 111, an output device 112, a communication device 113, an arithmetic unit 114, a main storage device 115, an external storage device 116, and a bus 117 which connects those components to one another.

The communication device 113 is, for example, a wired communication device which performs wired communications through a network cable or a wireless communication device which performs wireless communications via an antenna. The communication device 113 performs communications to/from another apparatus connected to a network such as the network 50.

The arithmetic unit 114 is, for example, a central processing unit (CPU). The main storage device 115 is, for example, a memory device such as a random access memory (RAM). The external storage device 116 is a so-called nonvolatile storage device, such as a hard disk drive, a solid state drive (SSD), and a flash memory, which can store digital information.

The input device 111 is a device which receives input information, including a pointing device such as a keyboard and a mouse and a microphone functioning as a voice input device.

The output device 112 is a device which generates output information, including a display, a printer, and a speaker functioning as a voice output device.

The part type reception section 121, the manufacturing apparatus search section 122, the inspection apparatus search section 123, the supplier search unit 124, and the engineering level calculation section 125 which are included in the above-mentioned control unit 120 are realized by a program which causes the arithmetic unit 114 to perform processing. This program is stored within the main storage device 115, the external storage device 116, or a ROM drive (not shown), loaded onto the main storage device 115 before execution thereof, and executed by the arithmetic unit 114.

Further, the storage unit 130 is realized by the main storage device 115 and the external storage device 116.

Further, the communication unit 140 is realized by the communication device 113. Further, the input unit 150 is realized by the input device 111. Further, the output unit 160 is realized by the output device 112.

An example of the hardware configuration of the engineering level evaluation system 1 according to this embodiment has been described above. However, the present invention is not limited thereto, and the engineering level evaluation system 1 may be configured by using other hardware. For example, the engineering level evaluation system 1 may be a standalone supplier engineering level evaluation apparatus 100 that is not connected to the network 50.

Further, each storing section stored in the storage unit 130 may crawl to collect the information stored in an external storage device or another server device connected to the network 50 to update the information or may receive data transmitted from the supplier to update the information.

(Description of operation) Next, a description is made of an operation of the engineering level evaluation system 1 according to this embodiment.

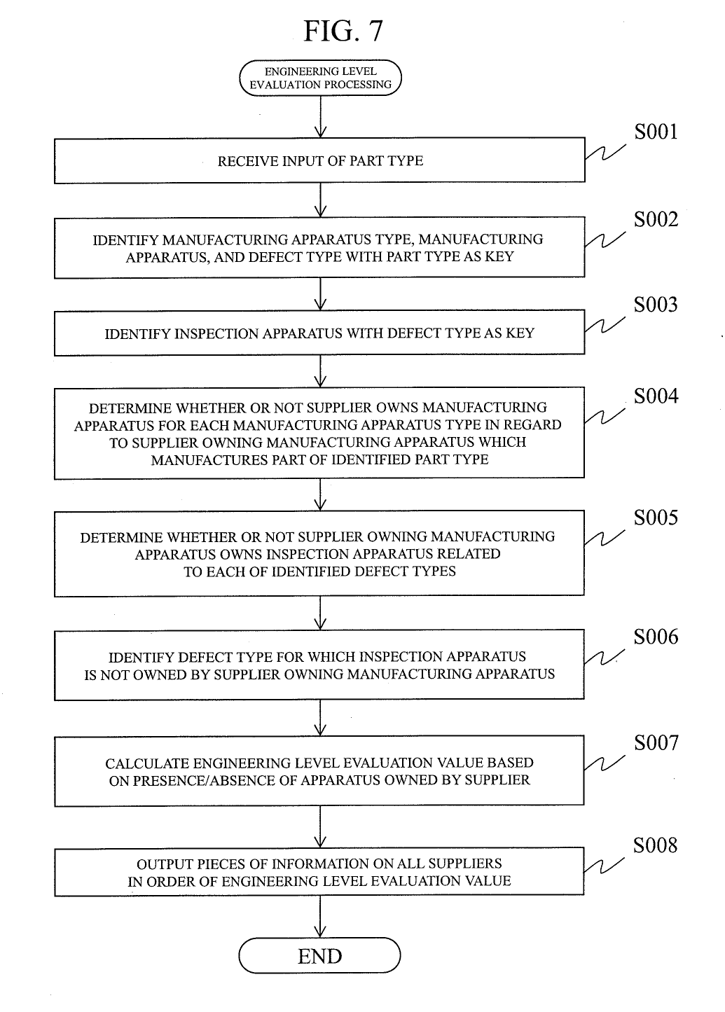

FIG. 7 is a diagram of a processing flow of engineering level evaluation processing carried out by the supplier engineering level evaluation apparatus 100 according to this embodiment. The engineering level evaluation processing is started when the supplier engineering level evaluation apparatus 100, which has been booted, receives an instruction to start the processing from the user.

First, the part type reception section 121 receives an input of the part type (Step S001). Specifically, the part type reception section 121 receives input information on the part type from the user via the input unit 150 or an input unit or the like provided to another terminal connected to the network 50. For example, the part type is a category such as “cast iron part” and “cast steel part”, but the present invention is not limited thereto, and the category may include a broader category “casting” or “pressed product”. Alternatively, a further narrower category may be used. In the example used in this processing flow, a case where “cast iron part” is input as the part type is described, but it should be understood that the present invention is not limited thereto.

Subsequently, the manufacturing apparatus search section 122 identifies a manufacturing apparatus type, the manufacturing apparatus, and the defect type with the part type as a key (Step S002). Specifically, with the part type whose input is received in Step S001 as a key, the manufacturing apparatus search section 122 searches for the part type 131a of the manufacturing apparatus defect information storing section 131, to identify the manufacturing apparatus type 131b, the manufacturing apparatus 131c, and the defect type 131d that correspond thereto. For example, when “cast iron part” is received as the part type via an input device, at least one record of the manufacturing apparatus defect information storing section 131 in which the part type 131a is “cast iron part” is identified, and a combination of the manufacturing apparatus type 131b, the manufacturing apparatus 131c, and the defect type 131d within the identified record is identified.

Subsequently, the inspection apparatus search section 123 identifies the inspection apparatus with the defect type as a key (Step S003). Specifically, the inspection apparatus search section 123 identifies the defect type 131d for each record identified in Step S002, and identifies at least one record of the inspection apparatus information storing section 132 in which the defect type 132a stores information corresponding to the defect type identified above, to identify the inspection apparatus 132b. For example, a combination of the defect type 132a and the inspection apparatus 132b is identified with the defect types “cavity”, “misrun”, and “casting surface defect” as keys.

Subsequently, the supplier search unit 124 determines whether or not the supplier owns the manufacturing apparatus for each manufacturing apparatus type in regard to the supplier owning the manufacturing apparatus which manufactures the part of the identified part type (Step S004). Specifically, the supplier search unit 124 determines whether or not the supplier owns at least one manufacturing apparatus in terms of each combination of the manufacturing apparatus type 131b and the manufacturing apparatus 131c identified in Step S002 in terms of the part type received in Step S001. For example, the supplier search unit 124 searches the owned manufacturing apparatus storing section 133 in terms of a combination of the manufacturing apparatus type and the manufacturing apparatus such as “melting furnace” and “high-frequency melting furnace”, “melting furnace” and “low-frequency melting furnace”, “casting apparatus” and “automatic casting apparatus”, “casting apparatus” and “handwork”, and “fettling apparatus” and “grinder”, to retrieve whether or not each of the suppliers “S1” and “S2” owns the manufacturing apparatus. In this case, when the manufacturing apparatus 133c stores “handwork”, it is assumed that the manufacturing apparatus is not owned. However, such exceptional processing as to assume that the manufacturing apparatus is owned even with “handwork” may be provided depending on the manufacturing apparatus type 133b.

Subsequently, the supplier search unit 124 determines whether or not the supplier owning the manufacturing apparatus which manufactures the part of the identified part type owns the inspection apparatus related to each of the identified defect types (Step S005). Specifically, the supplier search unit 124 refers to the inspection apparatus information storing section 132 and the owned inspection apparatus storing section 134 to identify the inspection apparatus 132b which can perform inspection for each defect type identified in Step S002, and determines whether or not each supplier owns the identified inspection apparatus 132b. In this case, when the inspection apparatus 134b stores “visual observation” or “handwork”, it is assumed that the inspection apparatus is not owned.

Subsequently, the supplier search unit 124 identifies the defect type for which the inspection apparatus is not owned by the supplier owning the manufacturing apparatus of the manufacturing apparatus type which manufactures the part of the identified part type (Step S006). Specifically, the supplier search unit 124 identifies the defect type for which at least one inspection apparatus is not owned by each supplier in regard to the defect type 131d identified in Step S002 for the part type received in Step S001, in other words, identifies the defect type for which the inspection cannot be performed. For example, in regard to the supplier “S2”, the inspection apparatus which performs the inspection for the predicted defect type “casting surface defect” is only “visual observation”, and hence the defect type for which the inspection apparatus is not owned is identified as “casting surface defect”.

Subsequently, the engineering level calculation section 125 calculates an engineering level evaluation point based on presence/absence of apparatus owned by the supplier (Step S007). Specifically, the engineering level calculation section 125 calculates the engineering level evaluation point based on an ownership rate of the manufacturing apparatus and an ownership rate of the inspection apparatus for performing the inspection for the defect assumed from the manufacturing apparatus. The following Expression (1) is a calculation expression for the ownership rate of the manufacturing apparatus.

$$Pi = \frac{{\sum }_{j = 1}^{M} Kj}{M} \qquad Expression ( 1 )$$

In Expression (1), Pi represents the ownership rate of the manufacturing apparatus of a supplier i, i represents a subscript for the supplier, M represents the number of types of manufacturing apparatus for the part type, Kj represents whether or not the manufacturing apparatus belonging to a manufacturing apparatus type j is owned, and j represents a subscript for the manufacturing apparatus.

In other words, according to Expression (1), it is possible to calculate the ownership rate of the manufacturing apparatus for each supplier. Further, the ownership rate of the manufacturing apparatus uses the number of types of manufacturing apparatus which manufactures a part of a predetermined part type as a denominator, and may be expressed as a coverage rate of the type of manufacturing apparatus which assumes that the manufacturing apparatus of the type is owned when even one manufacturing apparatus belonging to each type of manufacturing apparatus is owned.

The following Expression (2) is a calculation expression for the ownership rate of the inspection apparatus.

$$Qi = \frac{{\sum }_{j = 1}^{N} Lj}{N} \qquad Expression ( 2 )$$

In Expression (2), Qi represents the ownership rate of the inspection apparatus of a supplier i, i represents a subscript for the supplier, N represents the number of types of defect for the part type, Lj represents whether or not the inspection apparatus which can perform the inspection for a defect type j is owned, and j represents a subscript for the defect type.

In other words, according to Expression (2), it is possible to calculate the ownership rate of the inspection apparatus for each supplier. Further, the ownership rate of the inspection apparatus uses the number of types of defect caused in the manufacturing apparatus which manufactures the part of the predetermined part type as a denominator, and may be expressed as a coverage rate of the type of defect which assumes that the inspection apparatus for the defect type is owned when even one inspection apparatus which can perform the inspection for each defect type is owned.

The following Expression (3) is a calculation expression for the engineering level evaluation point based on the ownership rates of the manufacturing apparatus and the inspection apparatus.

Ti=Pi×Qi Expression (3)

In Expression (3), Ti represents the engineering level evaluation point of the supplier i, Pi represents the ownership rate of the manufacturing apparatus of the supplier i, Qi represents the ownership rate of the inspection apparatus of the supplier i, and i represents a subscript for the supplier.

In other words, according to Expression (3), it is possible to calculate the engineering level evaluation point for each supplier. Further, the engineering level evaluation point may be expressed as a point obtained by multiplying the ownership rate of the manufacturing apparatus by the ownership rate of the inspection apparatus.

For example, for each of the suppliers “S1” and “S2”, the engineering level calculation section 125 obtains the ownership rate of the manufacturing apparatus and the ownership rate of the inspection apparatus by using the information on Expression (1) and the presence/absence of the manufacturing apparatus for each type of manufacturing apparatus determined in Step S004 and the information on Expression (2) and the presence/absence of the inspection apparatus for each defect type determined in Step S005, respectively, and calculates the engineering level evaluation point of the supplier by using Expression (3).

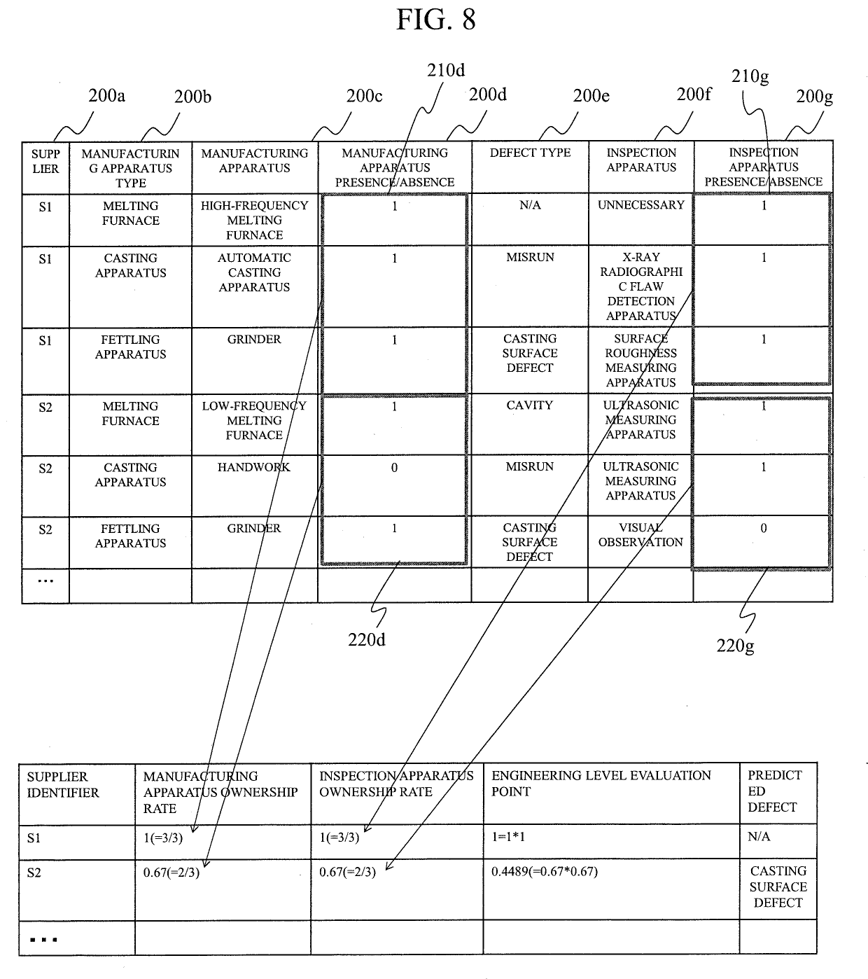

FIG. 8 is a diagram illustrating a calculation process as a processing example within the engineering level evaluation processing. FIG. 8 illustrates an example in which: manufacturing apparatus presence/absence 200d is identified for each combination of a supplier 200a, a manufacturing apparatus type 200b, and a manufacturing apparatus 200c; and a defect type 200e assumed for the each combination, an inspection apparatus 200f which performs the inspection for the defect type, and inspection apparatus presence/absence 200g are identified. In the example, the supplier S1 owns “high-frequency melting furnace” for “melting furnace”, “automatic casting apparatus” for “casting apparatus”, and “grinder” for “fettling apparatus”, and hence a manufacturing apparatus ownership rate of the supplier S1 is 3/3, in other words, “1” because one manufacturing apparatus is owned for each of three manufacturing apparatus types. Further, the supplier S1 owns “X-ray radiographic flaw detection apparatus” and “surface roughness measuring apparatus” for the defect types “misrun” and “casting surface defect”, respectively, on the assumption that the inspection apparatus is owned for the defect type “N/A”, and hence an inspection apparatus ownership rate of the supplier S1 is 3/3, in other words, “1” because one inspection apparatus is owned for each of three defect types. Accordingly, the engineering level evaluation point of the supplier S1 is calculated as “1”, and a predicted defect thereof is obtained as “N/A” because there is no defect that cannot be handled by the inspection apparatus.

Further, the supplier S2 owns “low-frequency melting furnace” for “melting furnace”, “handwork” for “casting apparatus”, and “grinder” for “fettling apparatus”, and hence the manufacturing apparatus ownership rate of the supplier S2 is 2/3, in other words, “0.67” because two manufacturing apparatus are owned for three manufacturing apparatus types. Further, the supplier S2 owns “ultrasonic measuring apparatus” for the defect type “cavity” and “ultrasonic measuring apparatus” for “misrun” with “visual observation” provided for “casting surface defect”, and hence the inspection apparatus ownership rate of the supplier S2 is 2/3, in other words, “0.67” because two inspection apparatus are owned for three defect types. Accordingly, the engineering level evaluation point of the supplier S2 is calculated as “0.4489”, and the defect that cannot be handled by the inspection apparatus is obtained as the casting surface defect for which the inspection is carried out only by “visual observation”.

Subsequently, the engineering level calculation section 125 outputs pieces of information on all the suppliers in order of the engineering level evaluation point (Step S008). Specifically, the engineering level calculation section 125 generates screen information which displays the pieces of information on the suppliers in descending order of the engineering level evaluation point calculated in Step S007.

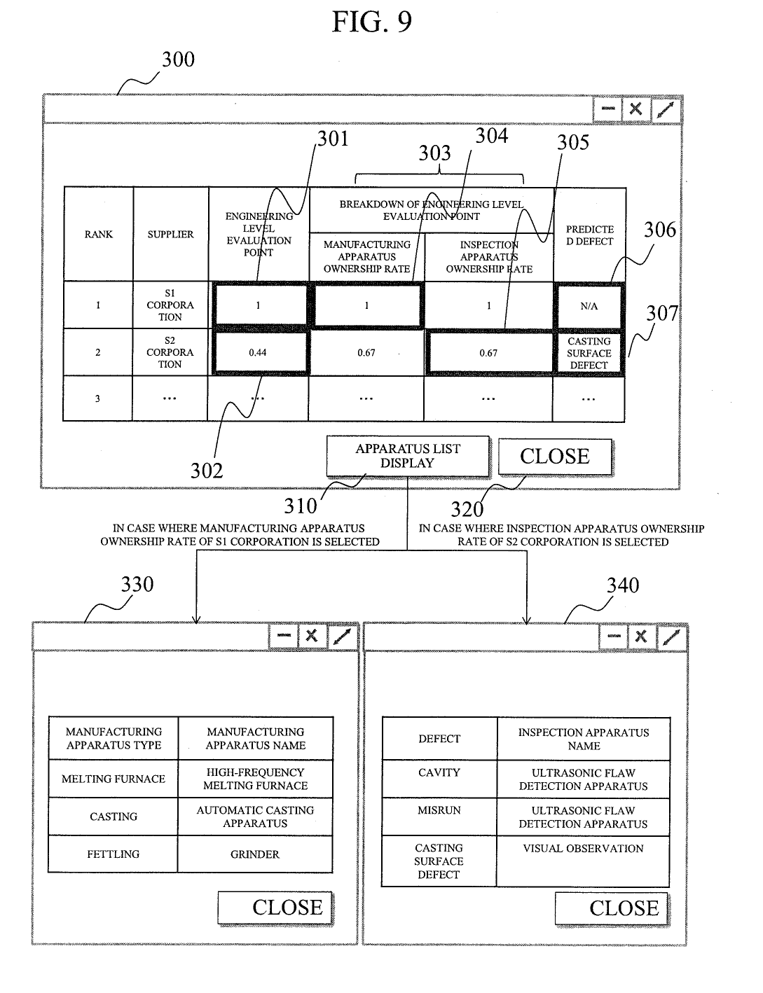

FIG. 9 is a diagram illustrating a screen 300 as an output example of the engineering level evaluation processing and sub screens thereof including a manufacturing apparatus list display screen 330 and an inspection apparatus list display screen 340. On the screen 300, the suppliers are displayed on the display in descending order of the engineering level evaluation point calculated in Step S007. For example, an engineering level evaluation point 301 of the supplier S1 is displayed as “1”, and an engineering level evaluation point 302 of the supplier S2 is displayed as “0.44”. Further, a breakdown 303 of the engineering level evaluation point is also displayed. For example, a manufacturing apparatus ownership rate 304 of the supplier S1 is displayed as “1”, and an inspection apparatus ownership rate 305 of the supplier S2 is displayed as “0.67”. Further, a predicted defect 306 predicted for the supplier S1 is displayed as “N/A”, and a predicted defect 307 predicted for the supplier S2 is displayed as “casting surface defect”.

Further displayed on the screen 300 are an apparatus list display button 310 which receives an instruction to display a list of apparatus and a close button 320 which receives an instruction to close the screen 300.

When an input is received through the apparatus list display button 310 with the manufacturing apparatus ownership rate 304 of the supplier S1 selected, the engineering level calculation section 125 displays the manufacturing apparatus list display screen 330. On the manufacturing apparatus list display screen 330, the information on the type of the manufacturing apparatus of the supplier S1 and the information on the owned manufacturing apparatus are displayed. Further displayed on the manufacturing apparatus list display screen 330 is a close button which erases the display of the manufacturing apparatus list display screen 330 when receiving an input therethrough. Further, when an input is received through the apparatus list display button 310 with the inspection apparatus ownership rate 305 of the supplier S2 selected, the engineering level calculation section 125 displays the inspection apparatus list display screen 340. On the inspection apparatus list display screen 340, the information on a defect type of the supplier S2 and the information on the owned inspection apparatus are displayed. Further displayed on the inspection apparatus list display screen 340 is a close button which erases the display of the inspection apparatus list display screen 340 when receiving an input therethrough.

Details of the engineering level evaluation processing according to the first embodiment have been described above. According to the engineering level evaluation processing, the user can input the type of a part to learn about the supplier which can manufacture the part with appropriate quality based on the engineering level.

The engineering level evaluation system 1 to which the first embodiment of the present invention is applied has been described above with reference to the accompanying drawings. According to the first embodiment in which the engineering level evaluation processing is carried out, the supplier which can manufacture the part corresponding to the input part type with the appropriate quality can be identified, and hence it is possible to speedily assist planning for a manufacturing plan. Further, by observing the type of the defect predicted to occur in the part provided from the supplier, the user can determine whether or not the defect is allowable in consideration of the processing technology, facilities, and the like of the own company, and can place an order thereof. Note that, the information on the type of the defect predicted to occur in the part provided from the supplier is information for obtaining a higher effect, and is not information essential to the present invention.

The present invention is not limited to the above-mentioned first embodiment. Various modifications can be made to the above-mentioned first embodiment within the scope of technical thoughts of the present invention. For example, in the above-mentioned first embodiment, evaluation is performed based on whether or not the supplier owns the manufacturing apparatus and the inspection apparatus, but the present invention is not limited thereto. For example, the evaluation may be limited to any one of apparatus, or an apparatus that can be used instead of “owned” may be evaluated. This allows the engineering level evaluation to become closer to actual conditions. Further, for example, further specific evaluation may be performed based on a grade by subdividing the owned manufacturing apparatus and the owned inspection apparatus and assigning grades thereto. This allows the engineering level to be measured more finely, and facilitates the evaluation of the supplier in more detail.

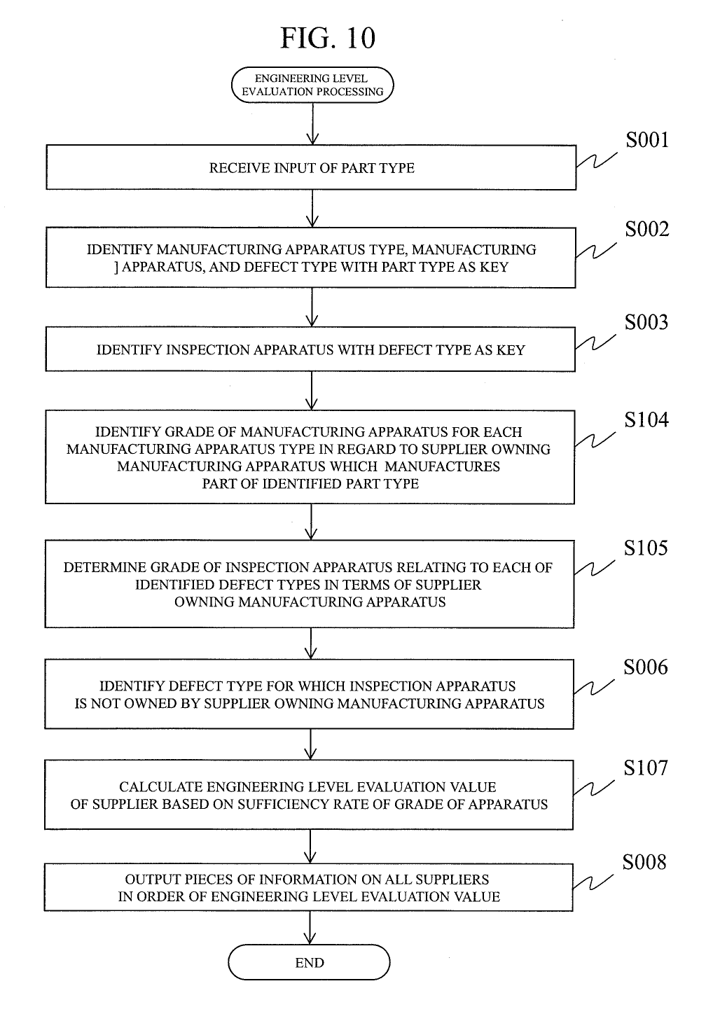

For example, such a second embodiment of the present invention is described with reference to FIG. 10 to FIG. 12. Note that, the second embodiment has substantially the same configuration as that of the above-mentioned first embodiment, and hence different points therebetween are mainly described.

FIG. 10 is a diagram illustrating a processing flow of the engineering level evaluation processing according to the second embodiment. The engineering level evaluation processing according to the second embodiment is basically the same as the engineering level evaluation processing according to the first embodiment except that the processing of Step S104, the processing of Step S105, and the processing of Step S107 are carried out instead of the processing of Step S004, the processing of Step S005, and the processing of Step S007, respectively.

The supplier search unit 124 determines the grade of the manufacturing apparatus for each manufacturing apparatus type in regard to the supplier owning the manufacturing apparatus which manufactures the part of the identified part type (Step S104). Specifically, the supplier search unit 124 determines the owned manufacturing apparatus and the grade thereof for each combination of the manufacturing apparatus type 131b and the manufacturing apparatus 131c identified in Step S002 in regard to the part type received in Step S001. For example, the supplier search unit 124 searches the owned manufacturing apparatus storing section 133 for the grade of the manufacturing apparatus owned by each of the suppliers “S1” and “S2” for each of the combinations of the manufacturing apparatus type and the manufacturing apparatus which include “melting furnace” and “high-frequency melting furnace”, “melting furnace” and “low-frequency melting furnace”, “casting apparatus” and “automatic casting apparatus”, “casting apparatus” and “handwork”, and “fettling apparatus” and “grinder”.

Note that, in regard to the grade of the manufacturing apparatus, it is assumed that, although not shown, the storage unit 130 stores a definition of the grade of each manufacturing apparatus and information defining the maximum grade for each manufacturing apparatus type. In this case, when the manufacturing apparatus 133c stores “handwork”, it is assumed that the grade of manufacturing apparatus is the minimum grade. However, such exceptional processing as to assume that the manufacturing apparatus is owned even with “handwork” may be provided depending on the manufacturing apparatus type 133b.

Subsequently, the supplier search unit 124 identifies the grade of the inspection apparatus relating to each of the identified defect types in terms of the supplier owning the manufacturing apparatus which manufactures the part of the identified part type (Step S105). Specifically, the supplier search unit 124 refers to the inspection apparatus information storing section 132 and the owned inspection apparatus storing section 134 to identify the inspection apparatus 132b which can perform the inspection for each of the defect types identified in Step S002, to determine the grade of the inspection apparatus 132b owned by each supplier. Note that, in regard to the grade of the inspection apparatus, it is assumed that, although not shown, the storage unit 130 stores a definition of the grade for each inspection apparatus and information defining the maximum grade for each defect type. In this case, when the inspection apparatus 134b stores “visual observation” or “handwork”, it is assumed that the grade of the inspection apparatus is the minimum grade.

Subsequently, the engineering level calculation section 125 calculates the engineering level evaluation point of the supplier based on the grade of the apparatus owned thereby (Step S107). Specifically, the engineering level calculation section 125 calculates the engineering level evaluation point based on a sufficiency rate of the manufacturing apparatus in consideration of the grade thereof and the sufficiency rate of the inspection apparatus for performing the inspection for the defect assumed from the manufacturing apparatus in consideration of the grade thereof. The following Expression (4) is a calculation expression for the sufficiency rate of the manufacturing apparatus in consideration of the grade thereof.

$$Pi = \frac{{\sum }_{j = 1}^{M} Gj}{{\sum }_{j = 1}^{M} {Gj}_{max}} \qquad Expression ( 4 )$$

In Expression (4), Pi represents the sufficiency rate of the manufacturing apparatus of a supplier i, Gi represents the grade of the manufacturing apparatus of the supplier i, i represents a subscript for the supplier, M represents the number of types of manufacturing apparatus for the part type, Gjₘₐₓ represents the maximum value of the grade of the manufacturing apparatus belonging to a manufacturing apparatus type j, and j represents a subscript for the manufacturing apparatus.

In other words, according to Expression (4), it is possible to calculate the sufficiency rate of the manufacturing apparatus for each supplier. Further, the sufficiency rate of the manufacturing apparatus uses a sum of maximum values of grades for each type of manufacturing apparatus which manufactures the part of a predetermined part type as a denominator, and may be expressed as the sufficiency rate of the owned manufacturing apparatus to the maximum grade of the manufacturing apparatus belonging for each type of manufacturing apparatus.

The following Expression (5) is a calculation expression for the sufficiency rate of the inspection apparatus.

$$Qi = \frac{{\sum }_{j = 1}^{N} Lj}{{\sum }_{j = 1}^{N} {Lj}_{max}} \qquad Expression ( 5 )$$

In Expression (5), Qi represents the sufficiency rate of the inspection apparatus of a supplier i, Lj represents the grade of the inspection apparatus for a defect type j of the supplier i, i represents a subscript for the supplier, N represents the number of types of defect for the part type, Ljₘₐₓ represents the maximum value of the grade of the inspection apparatus which can perform the inspection for the defect type j, and j represents a subscript for the defect type.

In other words, according to Expression (5), it is possible to calculate the sufficiency rate of the inspection apparatus for each supplier. Further, the sufficiency rate of the inspection apparatus uses the number of types of defect caused in the manufacturing apparatus which manufactures the part of the predetermined part type as a denominator, and may be expressed as a sufficiency rate of the owned inspection apparatus to the maximum grade of inspection apparatus which can perform the inspection for each defect type.

The following Expression (6) is a calculation expression for the engineering level evaluation point based on the sufficiency rates of the manufacturing apparatus and the inspection apparatus.

Ti=Pi×Qi Expression (6)

In Expression (6), Ti represents the engineering level evaluation point of the supplier i, Pi represents the sufficiency rate of the manufacturing apparatus of the supplier i, Qi represents the sufficiency rate of the inspection apparatus of the supplier i, and i represents a subscript for the supplier.

In other words, according to Expression (6), it is possible to calculate the engineering level evaluation point for each supplier. Further, the engineering level evaluation point may be expressed as a point obtained by multiplying the sufficiency rate of the manufacturing apparatus by the sufficiency rate of the inspection apparatus.

For example, for each of the suppliers “S1” and “S2”, the engineering level calculation section 125 obtains the sufficiency rate of the manufacturing apparatus and the sufficiency rate of the inspection apparatus by using the information on Expression (4) and the grade of the manufacturing apparatus for each type of manufacturing apparatus determined in Step S104 and the information on Expression (5) and the grade of the inspection apparatus for each defect type determined in Step S105, respectively, and calculates the engineering level evaluation point of the supplier by using Expression (6).

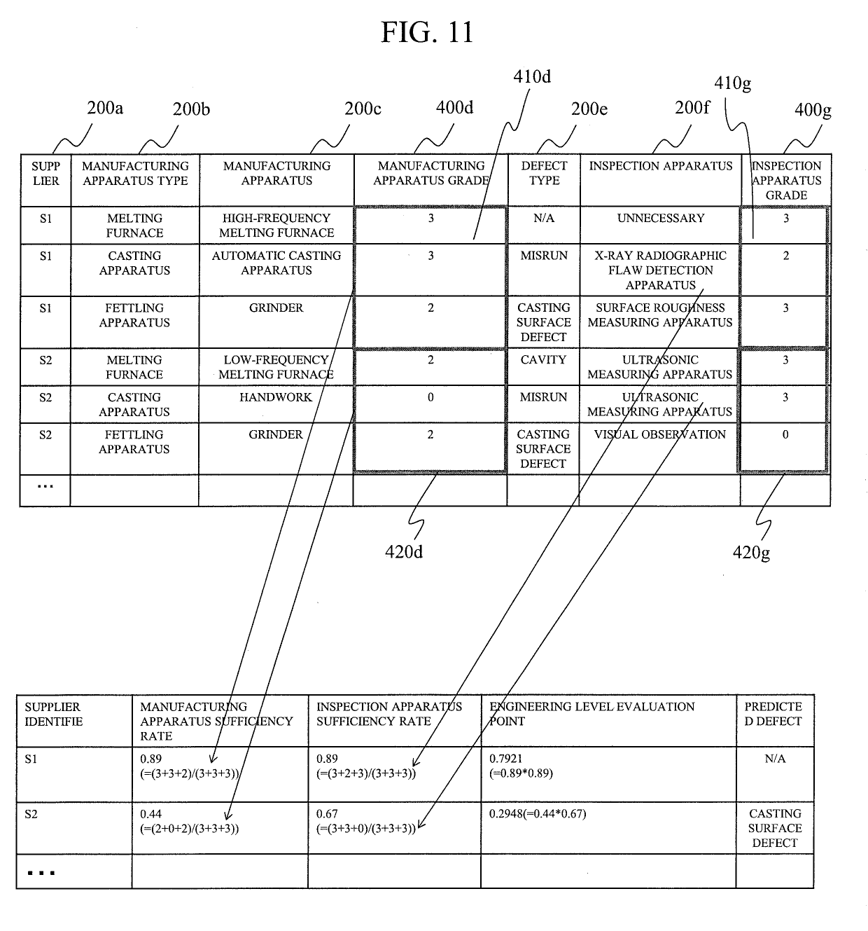

FIG. 11 is a diagram illustrating a calculation process as a processing example within the engineering level evaluation processing. FIG. 11 illustrates an example in which: a manufacturing apparatus grade 400d is identified for each combination of a supplier 200a, a manufacturing apparatus type 200b, and a manufacturing apparatus 200c; and a defect type 200e assumed for the each combination, an inspection apparatus 200f which performs the inspection for the defect type, and an inspection apparatus grade 400g are identified.

In the example, the supplier S1 owns “high-frequency melting furnace” having a grade of 3 for “melting furnace”, “automatic casting apparatus” having a grade of 3 for “casting apparatus”, and “grinder” having a grade of 2 for “fettling apparatus”, and hence a manufacturing apparatus sufficiency rate of the supplier S1 is 8/9, in other words, “0.89”. Further, the supplier S1 owns “X-ray radiographic flaw detection apparatus” having a grade of 2 and “surface roughness measuring apparatus” having a grade of 3 for the defect types “misrun” and “casting surface defect”, respectively, on the assumption that the inspection apparatus having a grade of 3 is owned for the defect type “N/A”, and hence an inspection apparatus sufficiency rate of the supplier S1 is 8/9, in other words, “0.89”. Accordingly, the engineering level evaluation point of the supplier S1 is calculated as “0.7921”, and a predicted defect thereof is obtained as “N/A” because there is no defect that cannot be handled by the inspection apparatus.

Further, the supplier S2 owns “low-frequency melting furnace” having a grade of 2 for “melting furnace”, “handwork” having a grade of 0 for “casting apparatus”, and “grinder” having a grade of 2 for “fettling apparatus”, and hence the manufacturing apparatus sufficiency rate of the supplier S2 is 4/9, in other words, “0.44”.Further, the supplier S2 owns “ultrasonic measuring apparatus” having a grade of 3 for the defect type “cavity” and “ultrasonic measuring apparatus” having a grade of 3 for “misrun” with “visual observation” having a grade of 0 provided for “casting surface defect”, and hence the inspection apparatus sufficiency rate of the supplier S2 is 6/9, in other words, “0.67”. Accordingly, the engineering level evaluation point of the supplier S2 is calculated as “0.2948”, and the defect that cannot be handled by the inspection apparatus is obtained as the casting surface defect for which the inspection is carried out only by “visual observation”.

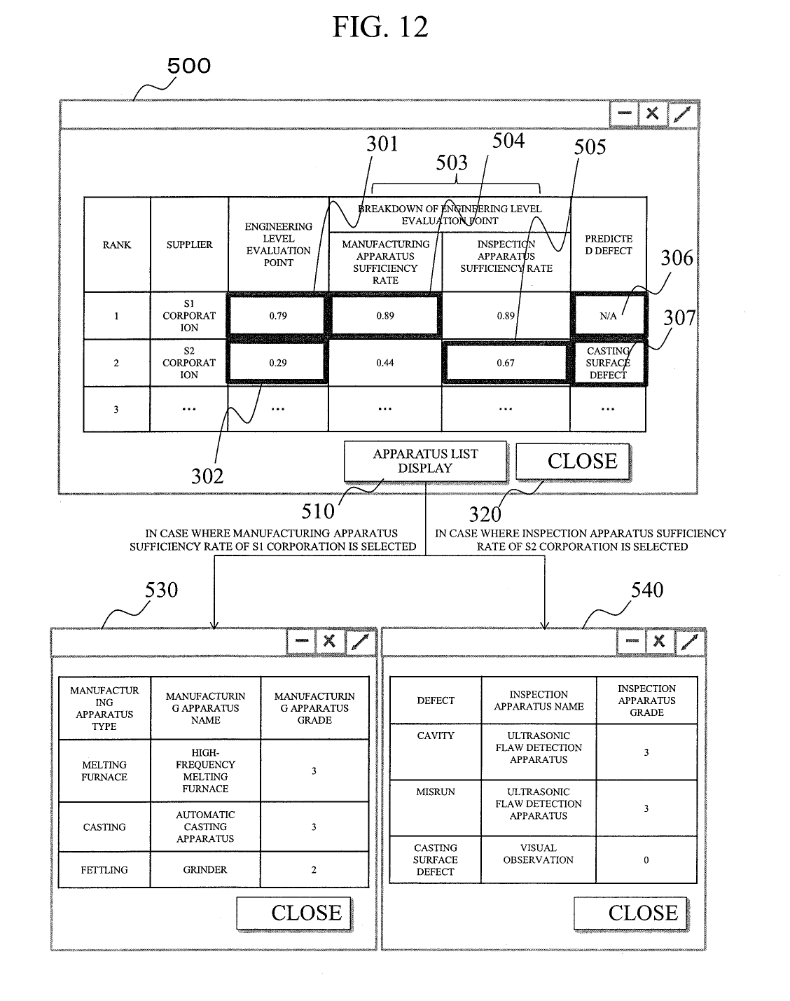

FIG. 12 is a diagram illustrating a screen 500 as an output example of the engineering level evaluation processing according to the second embodiment and sub screens thereof including a manufacturing apparatus list display screen 530 and an inspection apparatus list display screen 540. On the screen 500, the suppliers are displayed on the display in descending order of the engineering level evaluation point calculated in Step S107. For example, an engineering level evaluation point 301 of the supplier S1 is displayed as “0.79”, and an engineering level evaluation point 302 of the supplier S2 is displayed as “0.29”. Further, a breakdown 503 of the engineering level evaluation point is also displayed. For example, a manufacturing apparatus sufficiency rate 504 of the supplier S1 is displayed as “0.89”, and an inspection apparatus sufficiency rate 505 of the supplier S2 is displayed as “0.67”. Further, a predicted defect 306 predicted for the supplier S1 is displayed as “N/A”, and a predicted defect 307 predicted for the supplier S2 is displayed as “casting surface defect”. Further displayed on the screen 500 are an apparatus list display button 510 which receives an instruction to display a list of apparatus and a close button 320 which receives an instruction to close the screen 500.

Further, when an input is received through the apparatus list display button 510 with the manufacturing apparatus sufficiency rate 504 of the supplier S1 selected, the engineering level calculation section 125 displays the manufacturing apparatus list display screen 530. On the manufacturing apparatus list display screen 530, the information on the type of the manufacturing apparatus of the supplier S1, the information on the owned manufacturing apparatus, and the grade information on the owned manufacturing apparatus are displayed. Further displayed on the manufacturing apparatus list display screen 530 is a close button which erases the display of the manufacturing apparatus list display screen 530 when receiving an input therethrough. Further, when an input is received through the apparatus list display button 510 with the inspection apparatus sufficiency rate 505 of the supplier S2 selected, the engineering level calculation section 125 displays the inspection apparatus list display screen 540. On the inspection apparatus list display screen 540, the information on a defect type of the supplier S2, the information on the owned inspection apparatus, and the grade information on the owned inspection apparatus are displayed. Further displayed on the inspection apparatus list display screen 540 is a close button which erases the display of the inspection apparatus list display screen 540 when receiving an input therethrough.

Details of the engineering level evaluation processing according to the second embodiment have been described above. According to the engineering level evaluation processing of the second embodiment, the user can input the type of a part to learn about the supplier which can manufacture the part with appropriate quality based on the engineering level.

The engineering level evaluation system 1 to which the second embodiment of the present invention is applied has been described above with reference to the accompanying drawings. According to the second embodiment in which the engineering level evaluation processing is carried out, the supplier which can manufacture the part corresponding to the input part type with the appropriate quality can be identified more finely than in the first embodiment, and hence it is possible to speedily assist planning for a manufacturing plan. Further, by observing the type of the defect predicted to occur in the part provided from the supplier, the user can determine whether or not the defect is allowable in consideration of the processing technology, facilities, and the like of the own company, and can place an order thereof. Note that, the information on the type of the defect predicted to occur in the part provided from the supplier is information for obtaining a higher effect, and is not information essential to the present invention.

Further, for example, the sufficiency rate of the owned manufacturing apparatus and the sufficiency rate of the owned inspection apparatus may each be changed depending on an owned period to perform the evaluation more appropriately. This allows the engineering level to be measured more appropriately, and facilitates the evaluation of the supplier in more detail.

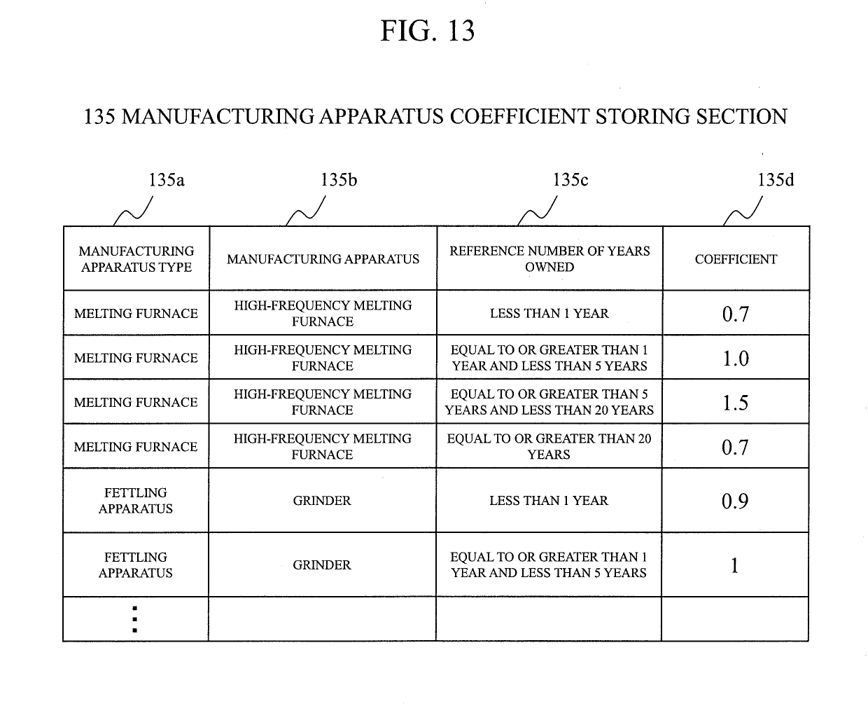

For example, such a third embodiment of the present invention is described with reference to FIG. 13 to FIG. 18. Note that, the third embodiment has substantially the same configuration as those of the above-mentioned first and second embodiments, and hence different points therebetween are mainly described.

FIG. 13 shows a data structure of a manufacturing apparatus coefficient storing section 135 stored in the storage unit 130 according to the third embodiment. The manufacturing apparatus coefficient storing section 135 stores a plurality of pieces of information in each of which a manufacturing apparatus type 135a, a manufacturing apparatus 135b, a reference number of years owned 135c, and a coefficient 135d are associated with one another. The manufacturing apparatus type 135a is information identifying a type of the manufacturing apparatus 135b, and examples thereof include “melting furnace”. The manufacturing apparatus 135b is information identifying the manufacturing apparatus, and examples thereof include “high-frequency melting furnace”. The reference number of years owned 135c is information identifying a reference number of years owned used to identify the coefficient 135d in accordance with the number of years for which the manufacturing apparatus is owned, and examples thereof include “less than 1 year” and “equal to or greater than 1 year and less than 5 years”. The coefficient 135d is a coefficient applied to the grade in accordance with the reference number of years owned 135c. The coefficient 135d is basically the coefficient for weighting the grade on the assumption that a level of skill increases over time, but is set to such a value as to decrease the weight in advance because obsolescence and deterioration of the technology and the like need to be taken into consideration when the number of years owned exceeds equal to or greater than a fixed number. In other words, the manufacturing apparatus coefficient storing section 135 stores data used for obtaining a degree of use of the manufacturing apparatus and an obsolescence degree of the manufacturing apparatus, which change depending on the number of years owned, by coefficients.

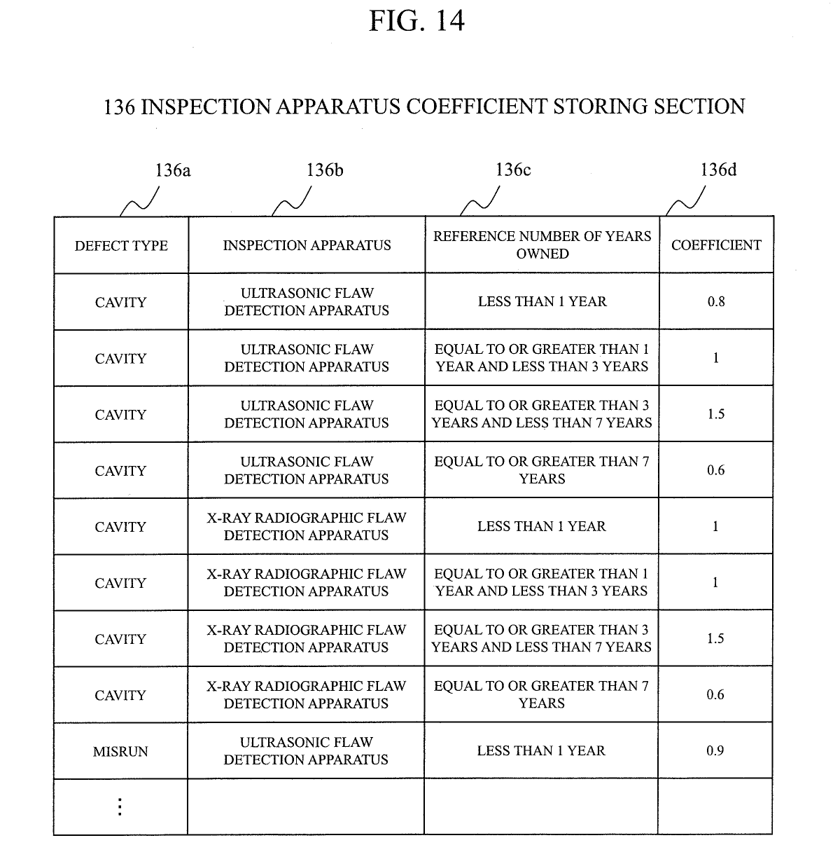

FIG. 14 shows a data structure of an inspection apparatus coefficient storing section 136 stored in the storage unit 130 according to the third embodiment. The inspection apparatus coefficient storing section 136 stores a plurality of pieces of information in each of which a defect type 136a, an inspection apparatus 136b, a reference number of years owned 136c, and a coefficient 136d are associated with each other. The defect type 136a is information identifying a kind of the defect that can be detected by the inspection apparatus 136b, and examples thereof include “cavity”. The inspection apparatus 136b is information identifying an inspection apparatus, and examples thereof include “ultrasonic flaw detection apparatus”. The reference number of years owned 136c is information identifying a reference number of years owned used to identify the coefficient 136d in accordance with the number of years for which the manufacturing apparatus is owned, and examples thereof include “less than 1 year” and “equal to or greater than 1 year and less than 3 years”. The coefficient 136d is a coefficient applied to the grade in accordance with the reference number of years owned 136c. The coefficient 136d is basically the coefficient for weighting the grade on the assumption that the level of skill increases over time, but is set to such a value as to decrease the weight in advance because the obsolescence and deterioration of the technology and the like need to be taken into consideration when the number of years owned exceeds equal to or greater than a fixed number. In other words, the inspection apparatus coefficient storing section 136 stores data used for obtaining a degree of use of the inspection apparatus and an obsolescence degree of the inspection apparatus, which change depending on the number of years owned, by coefficients.

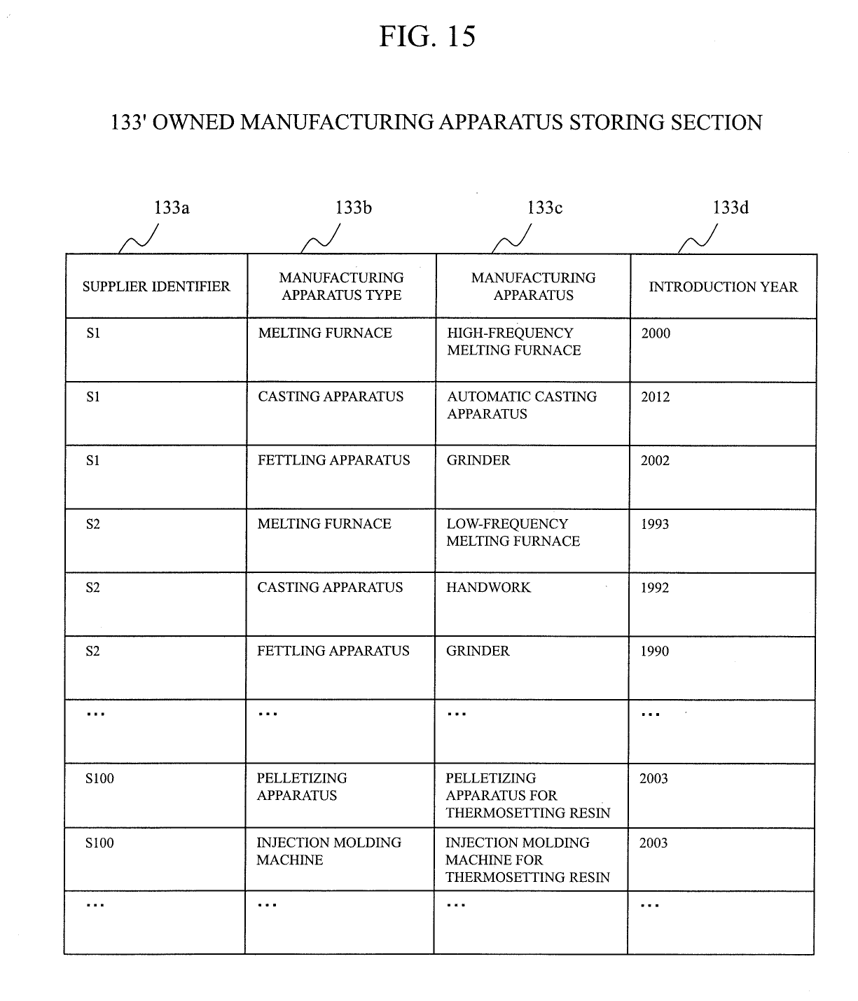

FIG. 15 shows a data structure of an owned manufacturing apparatus storing section 133′ stored in the storage unit 130 according to the third embodiment. Unlike the owned manufacturing apparatus storing section 133 according to the first embodiment, the owned manufacturing apparatus storing section 133′ stores an introduction year 133d in association.

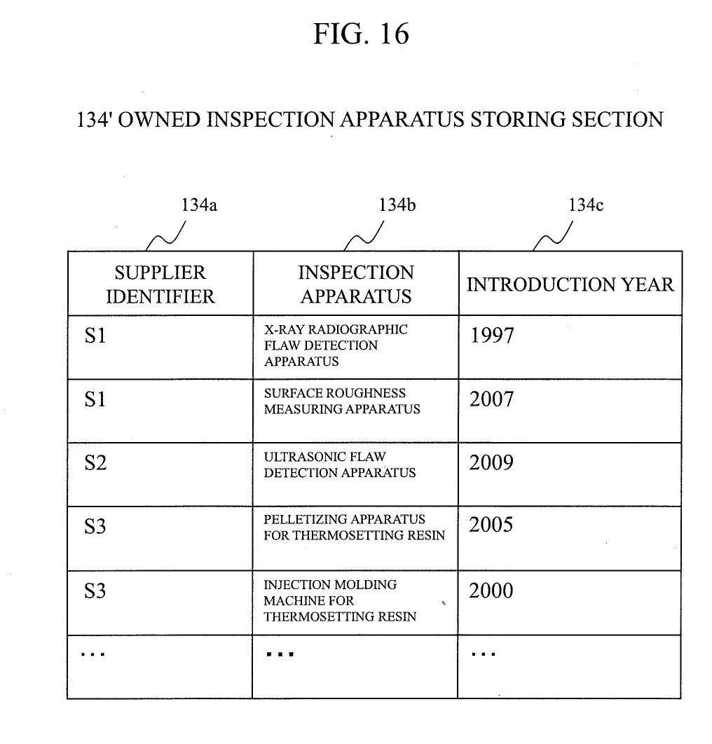

FIG. 16 shows a data structure of an owned inspection apparatus storing section 134′ stored in the storage unit 130 according to the third embodiment. Unlike the owned inspection apparatus storing section 134 according to the first embodiment, the owned inspection apparatus storing section 134′ stores an introduction year 134c in association.

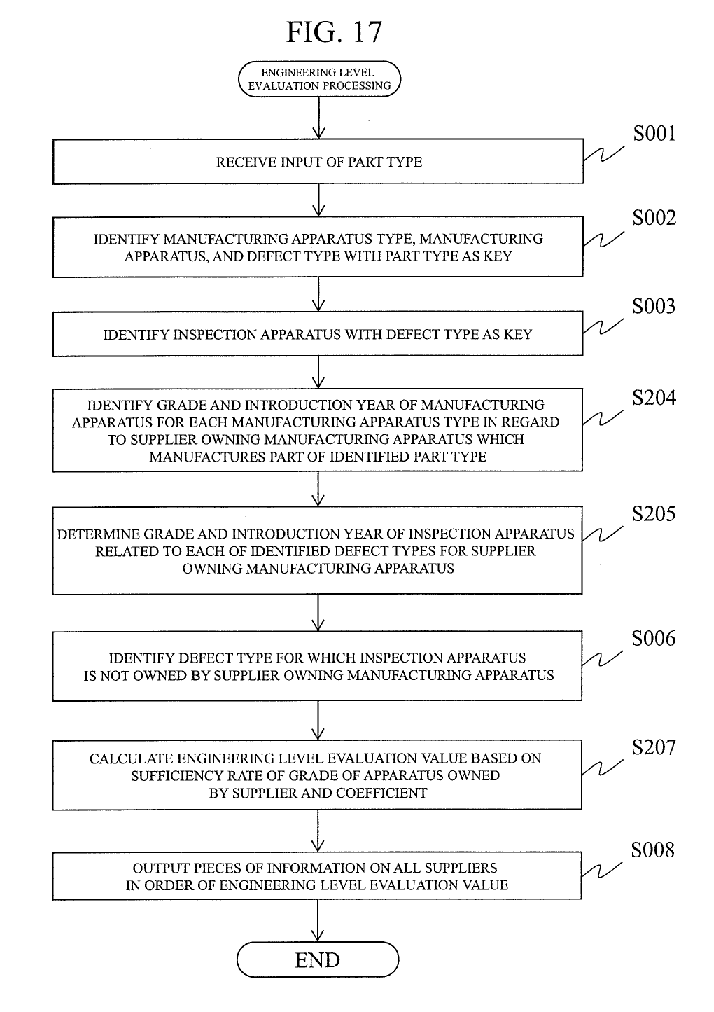

FIG. 17 is a diagram illustrating a processing flow of the engineering level evaluation processing according to the third embodiment. The engineering level evaluation processing according to the third embodiment is basically the same as the engineering level evaluation processing according to the second embodiment except that the processing of Step S204, the processing of Step S205, and the processing of Step S207 are carried out instead of the processing of Step S104, the processing of Step S105, and the processing of Step S107, respectively.

The supplier search unit 124 determines the grade and introduction year of the manufacturing apparatus for each manufacturing apparatus type in regard to the supplier owning the manufacturing apparatus which manufactures the part of the identified part type (Step S204). Specifically, the supplier search unit 124 determines the owned manufacturing apparatus and the grade and introduction year thereof for each combination of the manufacturing apparatus type 131b and the manufacturing apparatus 131c identified in Step S002 in regard to the part type received in Step S001.

For example, the supplier search unit 124 searches the owned manufacturing apparatus storing section 133′ for the grade and introduction year 133d of the manufacturing apparatus owned by each of the suppliers “S1” and “S2” for each of the combinations of the manufacturing apparatus type and the manufacturing apparatus which include “melting furnace” and “high-frequency melting furnace”, “melting furnace” and “low-frequency melting furnace”, “casting apparatus” and “automatic casting apparatus”, “casting apparatus” and “handwork”, and “fettling apparatus” and “grinder”. Note that, in regard to the grade of the manufacturing apparatus, it is assumed that, although not shown, the storage unit 130 stores a definition of the grade of each manufacturing apparatus and information defining the maximum grade and the introduction year 133d for each manufacturing apparatus type. In this case, when the manufacturing apparatus 133c stores “handwork”, it is assumed that the grade of manufacturing apparatus is the minimum grade. However, such exceptional processing as to assume that the manufacturing apparatus is owned even with “handwork” may be provided depending on the manufacturing apparatus type 133b.

Subsequently, the supplier search unit 124 identifies the grade and introduction year of the inspection apparatus relating to each of the identified defect types in terms of the supplier owning the manufacturing apparatus which manufactures the part of the identified part type (Step S205). Specifically, the supplier search unit 124 refers to the inspection apparatus information storing section 132 and the owned inspection apparatus storing section 134 to identify the inspection apparatus 132b which can perform the inspection for each of the defect types identified in Step S002, to determine the grade and introduction year of the inspection apparatus 132b owned by each supplier. Note that, in regard to the grade of the inspection apparatus, it is assumed that, although not shown, the storage unit 130 stores a definition of the grade of the inspection apparatus and information defining the maximum grade for each defect type. In this case, when the inspection apparatus 134b stores “visual observation” or “handwork”, it is assumed that the grade of the inspection apparatus is the minimum grade.

Subsequently, the engineering level calculation section 125 calculates the engineering level evaluation point of the supplier based on the grade and introduction year of the apparatus owned thereby (Step S207). Specifically, the engineering level calculation section 125 calculates the engineering level evaluation point based on a sufficiency rate of the manufacturing apparatus in consideration of the grade and introduction year thereof and the sufficiency rate of the inspection apparatus for performing the inspection for the defect assumed from the manufacturing apparatus in consideration of the grade and introduction year thereof. The following Expression (7) is a calculation expression for the maximum value of the grade of the manufacturing apparatus in consideration of the grade and introduction year thereof.

Gjₘₐₓ=Gi*Kiₘₐₓ Expression (7)

In Expression (7), Gjₘₐₓ represents the maximum value of the grade of the manufacturing apparatus type j, Gi represents the grade of the manufacturing apparatus of the supplier i, Kiₘₐₓ represents the maximum value of the coefficient with respect to a reference number of years owned of the manufacturing apparatus i, and i represents a subscript for the manufacturing apparatus of the highest grade within the manufacturing apparatus type j.

In other words, according to Expression (7), it is possible to consider the value of the grade used to calculate the sufficiency rate of the manufacturing apparatus for each supplier in accordance with the number of elapsed years since an introduction year. Further, the grade of the manufacturing apparatus is set to have a value obtained by multiplying the grade of each type of manufacturing apparatus which manufactures the part of a predetermined part type by the coefficient corresponding to the number of elapsed years, and may be expressed as the highest grade of the manufacturing apparatus belonging to each type of the manufacturing apparatus.

The following Expression (8) is a calculation expression for the maximum value of the grade of the inspection apparatus in consideration of the grade and the introduction year.

Ljₘₐₓ=Li*Hiₘₐₓ Expression (8)

In Expression (8), Ljₘₐₓ represents the maximum value of the grade of the defect type j, j represents a subscript for the defect type, Li represents the grade of the inspection apparatus i, Hiₘₐₓ represents the maximum value of the coefficient with respect to the reference number of years owned of the inspection apparatus i, and i represents a subscript for the inspection apparatus of the highest grade within the defect type j.

In other words, according to Expression (8), it is possible to consider the value of the grade used to calculate the sufficiency rate of the inspection apparatus for each supplier in accordance with the number of elapsed years since an introduction year. Further, the sufficiency rate of the inspection apparatus is set to have a value obtained by multiplying the grade of the defect type caused in the manufacturing apparatus which manufactures the part of a predetermined part type by the coefficient corresponding to the number of elapsed years, and may be expressed as the highest grade of the inspection apparatus which can perform the inspection for each defect type.

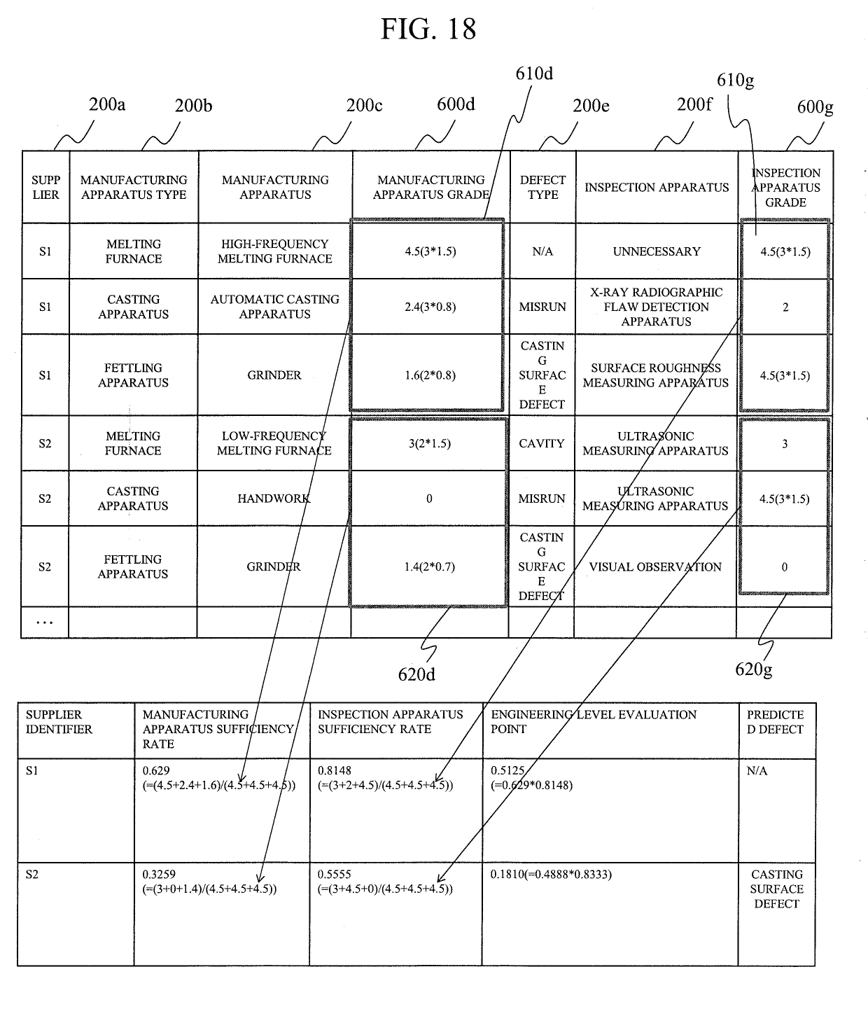

FIG. 18 is a diagram illustrating a calculation process as a processing example within the engineering level evaluation processing according to the third embodiment. FIG. 18 illustrates an example in which: a manufacturing apparatus grade 600d is identified for each combination of the supplier 200a, the manufacturing apparatus type 200b, and the manufacturing apparatus 200c; and the defect type 200e assumed for the each combination, the inspection apparatus 200f which performs the inspection for the defect type, and an inspection apparatus grade 600g are identified. In the example, a manufacturing apparatus sufficiency rate of the supplier S1 is 8.5/13.5, in other words, “0.629” because the supplier S1 owns: “high-frequency melting furnace” having a grade of 4.5, which is obtained by multiplying a grade of 3 by a coefficient of 1.5 corresponding to the number of years owned obtained from a difference between the introduction year and the present, for “melting furnace”; “automatic casting apparatus” having a grade of 2.4, which is obtained by multiplying a grade of 3 by a coefficient of 0.8 corresponding to the number of years owned obtained from the difference between the introduction year and the present, for “casting apparatus”; and “grinder” having a grade of 1.6, which is obtained by multiplying a grade of 2 by a coefficient of 0.8 corresponding to the number of years owned obtained from the difference between the introduction year and the present, for “fettling apparatus”.

Further, an inspection apparatus sufficiency rate of the supplier S1 is 11/13.5, in other words, “0.8148” because the supplier S1 owns: “X-ray radiographic flaw detection apparatus” having a grade of 2, which is obtained by multiplying a grade of 2 by a coefficient of 1 corresponding to the number of years owned obtained from the difference between the introduction year and the present, for the defect type “misrun”; and “surface roughness measuring apparatus” having a grade of 4.5, which is obtained by multiplying a grade of 3 by a coefficient of 1.5 corresponding to the number of years owned obtained from the difference between the introduction year and the present, for the defect type “casting surface defect”, on the assumption that the inspection apparatus having a grade of 4.5, which is obtained by multiplying a grade of 3 by a coefficient of 1.5 corresponding to the number of years owned obtained from the difference between the introduction year and the present, is owned for the defect type “N/A”. Accordingly, the engineering level evaluation point of the supplier S1 is calculated as “0.5125”, and the predicted defect is obtained as “N/A” because there is no defect that cannot be handled by the inspection apparatus.

Further, the manufacturing apparatus sufficiency rate of the supplier S2 is 4.4/13.5, in other words, “0.3259” because the supplier S2 owns: “low-frequency melting furnace” having a grade of 3, which is obtained by multiplying a grade of 2 by a coefficient of 1.5 corresponding to the number of years owned obtained from the difference between the introduction year and the present, for “melting furnace”; “handwork” having a grade of 0 for “casting apparatus”; and “grinder” having a grade of 1.4, which is obtained by multiplying a grade of 2 by a coefficient of 0.7 corresponding to the number of years owned obtained from the difference between the introduction year and the present, for “fettling apparatus”. Further, the inspection apparatus sufficiency rate of the supplier S2 is 7.5/13.5, in other words, “0.5555”, because the supplier S2 owns: “ultrasonic measuring apparatus” having a grade of 3, which is obtained by multiplying a grade of 3 by a coefficient of 1 corresponding to the number of years owned obtained from the difference between the introduction year and the present, for the defect type “cavity”; “ultrasonic measuring apparatus” having a grade of 4.5, which is obtained by multiplying a grade of 3 by a coefficient of 1.5 corresponding to the number of years owned obtained from the difference between the introduction year and the present, for “misrun”; and “visual observation” having a grade of 0 for “casting surface defect”. Accordingly, the engineering level evaluation point of the supplier S2 is calculated as “0.1810”, and the defect that cannot be handled by the inspection apparatus is obtained as the casting surface defect for which the inspection is carried out only by “visual observation”.

Details of the engineering level evaluation processing according to the third embodiment have been described above. According to the engineering level evaluation processing of the third embodiment, the user can input the type of a part to learn about the supplier which can manufacture the part with appropriate quality based on the engineering level.

The engineering level evaluation system 1 to which the third embodiment of the present invention is applied has been described above with reference to the accompanying drawings. According to the third embodiment in which the engineering level evaluation processing is carried out, the supplier which can manufacture the part corresponding to the input part type with the appropriate quality in consideration of the obsolescence of the technology and the like can be identified by being evaluated more finely than in the second embodiment, and hence it is possible to speedily assist planning for a manufacturing plan. Further, by observing the type of the defect predicted to occur in the part provided from the supplier, the user can determine whether or not the defect is allowable in consideration of the processing technology, facilities, and the like of the own company, and can place an order thereof. Note that, the information on the type of the defect predicted to occur in the part provided from the supplier is information for obtaining a higher effect, and is not information essential to the present invention.

Note that, the present invention is not limited to the above-mentioned embodiments, and includes further various modification examples. For example, in the above-mentioned embodiments, the configurations are described in detail in order to clearly describe the present invention, but the present invention is not necessarily limited to an embodiment that includes all the configurations that have been described. Further, a part of the configuration of a given embodiment can replace the configuration of another embodiment, and the configuration of another embodiment can also be added to the configuration of a given embodiment. Further, another configuration can be added to, deleted from, and replace a part of the configuration of each of the embodiments.

Further, in regard to each of the above-mentioned configurations, components, functions, processing units and sections, and the like, a part thereof or an entirety thereof may be realized by hardware, for example, by being designed as an integrated circuit. Further, control lines and information lines that are assumed to be necessary for the sake of description are illustrated, but not all the control lines and the information lines on a product are illustrated. In actuality, it may be considered that almost all the components are connected to one another.

Further, technical elements of the above-mentioned embodiments may be applied alone, or may be applied by being divided into a plurality of portions such as program parts and hardware parts.

The embodiments of the present invention have been mainly described above.

What is claimed is:

1. An engineering level evaluation apparatus, comprising:
a storage unit which stores:
device information in which information on a part and an apparatus relating to manufacturing of the part are associated with each other; and
apparatus owning information in which information identifying a supply entity of the part and the apparatus used by the supply entity are associated with each other;
apart information reception section which receives an input of the information on the part;
an engineering level calculation section which identifies a degree to which the apparatus relating to the manufacturing of the part received by the part information reception section is usable, and uses the degree to calculate an engineering level of each supply entity; and
an output unit which outputs the supply entities in order of the engineering level.

2. An engineering level evaluation apparatus according to claim 1, wherein the engineering level calculation section identifies the degree to which the apparatus relating to the manufacturing is usable based on whether or not the apparatus is owned.

3. An engineering level evaluation apparatus according to claim 1, wherein the engineering level calculation section identifies the degree to which the apparatus relating to the manufacturing is usable based on performance of the apparatus owned by the supply entity.

4. An engineering level evaluation apparatus according to claim 1, wherein the engineering level calculation section identifies the degree to which the apparatus relating to the manufacturing is usable based on a period for which the apparatus owned by the supply entity is owned.

5. An engineering level evaluation apparatus according to claim 1, wherein:
the engineering level calculation section identifies a type of a defect, which is liable to occur when the apparatus relating to the manufacturing is used, for each supply entity; and
the output unit outputs the type of the defect for each supply entity.

6. An engineering level evaluation apparatus according to claim 1, wherein the apparatus relating to the manufacturing of the part comprises an apparatus which manufactures the part.

7. An engineering level evaluation apparatus according to claim 1, wherein the apparatus relating to the manufacturing of the part comprises an apparatus which performs inspection for the part.

8. An engineering level evaluation apparatus according to claim 1, wherein:
the apparatus used to manufacture the part comprises an apparatus which manufactures the part and an apparatus which performs inspection for the part;
the storage unit further comprises inspection device information in which a type of a defect, which is liable to occur when the apparatus which manufactures the part is used, and an inspection apparatus capable of performing the inspection for each type of the defect are associated with each other; and
the engineering level calculation section is configured to:
identify a degree to which the apparatus which manufactures the part received by the part information reception section is usable; and
identify a degree to which the apparatus which performs the inspection is usable for each type of the defect which is liable to occur when the apparatus which manufactures the part is used, and use the degrees to calculate the engineering level for each supply entity.

9. An engineering level evaluation method for evaluating an engineering level of a supply entity of a part by using a computer,
the computer comprising a storage unit which stores:
device information in which information on the part and an apparatus relating to manufacturing of the part are associated with each other; and
apparatus owning information in which information identifying the supply entity of the part and the apparatus used by the supply entity are associated with each other,
the engineering level evaluation method comprising:
receiving, by the computer, an input of the information on the part;
identifying, by the computer, a degree to which the apparatus relating to the manufacturing of the part received in the receiving of the input of the information on the part is usable, and using the degree to calculate the engineering level of each supply entity; and
outputting, by the computer, the supply entities in order of the engineering level.
